(19) United States
(12) Patent Application Publication
(10) Pub. No.: US 2017/0267557 A1
(43) Pub. Date: Sep. 21, 2017

(54) IN-SITU TREATMENT OF TAILINGS

(71) Applicant: SYNCRUDE CANADA LTD. in trust for the owners of the Syncrude Project as such owners exist now and, Fort McMurray (CA)

(72) Inventors: SIMON YUAN, Edmonton (CA); JAMES LORENTZ, Fort McMurray (CA)

(21) Appl. No.: 15/071,080

(22) Filed: Mar. 15, 2016

(51) Int. Cl. C02F 1/56; C02F 1/24

(52) U.S. Cl. CPC C02F 1/56; C02F 1/24; C02F 2103/10

(57) ABSTRACT

A process for the in-situ treatment of tailings in a containment area having a tailings layer comprising fine solids and water, is provided comprising: adding a flocculant, a coagulant, a hydrophobicity modifying agent, or any combination thereof, into a portion of the tailings layer; mixing the portion of the tailings layer and flocculant, coagulant, collector, or combinations thereof, to form in-situ treated tailings; and allowing the in-situ treated tailings to dewater and/or consolidate in-situ in the tailings containment area.

### FIELD OF THE INVENTION

The present invention relates generally to in-situ processes for dewatering tailings ponds such as oil sands tailings ponds. More particularly, a mobile facility is provided which can be located on or near a tailings pond for in-situ treatment of tailings.

### BACKGROUND OF THE INVENTION

Oil sand generally comprises water-wet sand grains held together by a matrix of viscous heavy oil or bitumen. Bitumen is a complex and viscous mixture of large or heavy hydrocarbon molecules which contain a significant amount of sulfur, nitrogen and oxygen. The extraction of bitumen from sand using hot water processes yields large volumes of tailings composed of sand, fine silts, clays and residual bitumen which have to be contained in a tailings pond. Mineral fractions with a particle diameter less than 44 microns are referred to as “fines.” These fines are typically quartz and clay mineral suspensions, predominantly kaolinite and illite.

Tailings produced during bitumen extraction are typically 50% water and 50% solids by weight. The solids fraction can be further defined as being either fine or coarse solids. Typically, the solid fraction contains 80% coarse and 20% fines by weight. Upon entry into the aqueous tailings storage pond the fines and the coarse material segregate. The majority of the coarse material settles rapidly to form beaches or pond bottom. However, the fines and a portion of the coarse material settle slowly over a period of years to a typical composition of 35% solids by weight, which composition is sometimes referred to a mature fine tailings or MFT. Hereinafter, the more general term of fluid fine tailings (FFT) will be used, which encompasses the spectrum of tailings from discharge to final settled state. As used herein, FFT generally refers to a suspension of oil sands fines in water with a solids content greater than 1% and having less than an undrained shear strength of 5 kPa.

The fluid fine tailings behave as a fluid colloidal-like material. The fact that fluid fine tailings behave as a fluid and have very slow consolidation rates limits options to reclaim tailings ponds. A challenge facing the industry remains the removal of water from the fluid fine tailings to increase the solids content well beyond 35 wt % and strengthen the deposits to the point that they can be reclaimed and no longer require containment.

Various processes have been developed by the industry to address the slow consolidation of FFT, for example, centrifugation, the TRO™ process, atmospheric fines drying, accelerated dewatering/rim ditching, etc. However, all of these processes require prior flocculation of FFT with a polymeric flocculant, hence, require FFT dredging, pumping and transporting from a tailings pond to another location (e.g., FFT treatment plants). The treated FFT must then be transported back to another designated deposition site for consolidation and desiccation. Thus, the capital and operation costs are a major concern.

Accordingly, there is a need for an in-situ method of dewatering tailings which can reduce capital and operation costs and enhance the effectiveness of FFT treatment.

### SUMMARY OF THE INVENTION

The current application is directed to a process for dewatering tailings ponds such as oil sands tailings ponds in-situ. By being able to treat tailings in-situ, one or more of the following benefits may be realized:
1. Reduction of capital and operation costs of FFT treatment through in-situ flocculation of FFT with a dredge or barge;
2. Reduction of the FFT pumping distances and costs;
3. Eliminating the requirement of an external pond/containment area; and
4. Eliminating the requirement to build a fixed FFT treatment plant.

Thus, broadly stated, in one aspect of the present invention, a process for the in-situ treatment of tailings in a containment area having a tailings layer comprising fine solids and water is provided, comprising:
adding a flocculant, a coagulant, a hydrophobicity modifying agent, or any combination thereof, into a portion of the tailings layer;
mixing the portion of the tailings layer and flocculant, coagulant, hydrophobicity modifying agent, or combinations thereof, to form in-situ treated tailings; and
allowing the in-situ treated tailings to dewater and/or consolidate in-situ in the tailings containment area.

Additional aspects and advantages of the present invention will be apparent in view of the description, which follows. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will now be described by way of an exemplary embodiment with reference to the accompanying simplified, diagrammatic, not-to-scale drawings:

FIG. 1 is a schematic of one embodiment of the present invention for in-situ consolidation of fluid fine tailings (FFT) present in a tailings pond.

FIG. 2 is a schematic showing another embodiment of the present invention for in-situ consolidation of fluid fine tailings (FFT) present in a tailings pond.

FIG. 3 is a schematic showing another embodiment of the present invention for in-situ consolidation of fluid fine tailings (FFT) present in a tailings pond.

FIG. 4 is a schematic showing an embodiment of the present invention for in-situ treatment of fluid fine tailings (FFT) present in a tailings pond designed to float clays therein for removal.

### DETAILED DESCRIPTION OF PREFERRED EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practised without these specific details.

The present invention relates generally to a process for dewatering tailings such as oil sands tailings, which are present in a tailings pond or other containment, by in-situ treatment with additives. Additives useful in the present invention include a flocculant, a coagulant, a hydrophobicity modifying agent, or any combination thereof. Flocculants and coagulants flocculate/agglomerate particles, thereby affecting the hydraulic conductivity and porosity. Hydrophobicity modifying agents are reagents that may reduce the affinity between clay and water and may significantly enhance the dewatering rate and hydraulic conductivity of clays in the deposit.

As used herein, the term “tailings” means any tailings produced during a mining operation and, in particular, tailings derived from oil sands extraction operations that contain a fines fraction, which are disposed of at a disposal site such as a tailings pond and the like. The term is meant to include fluid fine tailings (FFT) present in oil sands tailings ponds.

As used herein, “in-situ” means in the original, natural, or existing place. As used herein, “in-situ treatment” means treating tailings that are present in a tailings containment area such as a tailings pond with at least one chemical additive, whereby the treated tailings are allowed to dewater and/or consolidate in the tailings containment area.

As used herein, the term “flocculation” refers to a process of contact and adhesion whereby the particles of a dispersion form larger-size clusters in the form of flocs or aggregates. As used herein, the term “flocculant” refers to a reagent which promotes flocculation by bridging colloids and other suspended particles in liquids to aggregate, forming a floc. Flocculants useful in the present invention are generally anionic polymers, which may be naturally occurring or synthetic, having relatively high molecular weights. In one embodiment, the dosage of the anionic polymeric flocculant ranges from between about 0 to about 1500 grams per tonne of solids in the tailings.

Suitable natural polymeric flocculants may be polysaccharides such as guar gum, gelatin, alginates, chitosan, and isinglass. Suitable synthetic polymeric flocculants include, but are not limited to, polyacrylamides, for example, a high molecular weight, long-chain modified polyacrylamide (PAM). PAM is a polymer (—CH₂CHCONH₂—)ₙ formed from acrylamide subunits with the following structure:

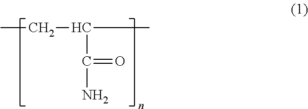

It can be synthesized as a simple linear-chain structure or cross-linked, typically using N,N′-methylenebisacrylamide to form a branched structure. Even though such compounds are often called “polyacrylamide,” many are copolymers of acrylamide and one or more other chemical species, such as an acrylic acid or a salt thereof. The “modified” polymer is thus conferred with a particular ionic character, i.e., changing the anionicity of the PAM. Preferably, the polyacrylamide anionic flocculants are characterized by molecular weights ranging between about 10 to about 24 million, and medium charge density (about 25-30% anionicity).

It will be appreciated by those skilled in the art that various modifications (e.g., branched or straight chain modifications, charge density, molecular weight, dosage) to the flocculant may be contemplated.

As used herein, the term “coagulation” refers to a process of neutralizing repulsive electrostatic charge (often negative) surrounding particles to cause them to collide and agglomerate under the influence of Van der Waals's forces. As used herein, the term “coagulant” refers to a reagent which neutralizes repulsive electrical charges surrounding particles to cause the particles to agglomerate. The term includes organic and inorganic coagulants.

A suitable organic coagulant useful in the present invention includes, but is not limited to, a cationic polymeric coagulant. In one embodiment, the dosage of the cationic polymeric coagulant ranges between about 0 to about 1000 grams per tonne of solids in the tailings. In one embodiment, the cationic polymeric coagulant comprises polydimethyldiallylammonium chloride (or polydiallyldimethylammonium chloride (abbreviated as “polyDADMAC” and having a molecular formula of (C₈H₁₆NCl)ₙ. In one embodiment, the polyDADMAC has a molecular weight ranging between about 6,000 to about 1 million, and a high charge density (about 100% cationicity). The monomer DADMAC is formed by reacting two equivalents of allyl chloride with dimethylamine. PolyDADMAC is then synthesized by radical polymerization of DADMAC with an organic peroxide used as a catalyst. Two polymeric structures are possible when polymerizing DADMAC: N-substituted piperidine structure or N-substituted pyrrolidine structure, with the pyrrolidine structure being favored. The polymerization process for polyDADMAC is shown as follows:

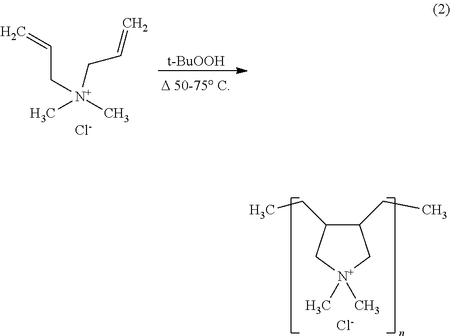

In one embodiment, cationic polymeric coagulants are more effective than inorganic cationic coagulants at the same dosages. However, suitable inorganic cationic coagulants useful in the present invention include, but are not limited to, alum, aluminum chlorohydrate, aluminum sulphate, lime (calcium oxide), slaked lime (calcium hydroxide), calcium chloride, magnesium chloride, iron (II) sulphate (ferrous sulphate), iron (III) chloride (ferric chloride), sodium aluminate, gypsum (calcium sulphate dehydrate), or any combination thereof. In one embodiment, the inorganic coagulants include multivalent cations. As used herein, the term “multivalent” means an element having more than one valence. Valence is defined as the number of valence bonds formed by a given atom. Suitable multivalent inorganic coagulants may comprise divalent or trivalent cations. Divalent cations increase the adhesion of bitumen to clay particles and the coagulation of clay particles, and include, but are not limited to, calcium (Ca²⁺), magnesium (Mg²⁺), and iron (Fe²⁺). Trivalent cations include, but are not limited to, aluminium (Al³⁺), iron (Fe³⁺).

As used herein, “aggregation” refers to the formation of clusters, flocs or aggregates in a colloidal suspension as a result of the addition of a flocculant, a coagulant, or both. Aggregation is also referred to herein as coagulation or flocculation.

As used herein, the term “hydrophobicity modifying agent” refers to a chemical reagent which increases the natural hydrophobicity of a mineral surface, in particular, clays, thereby decreasing the mineral's affinity to water. For example, such reagents can adsorb physically onto mineral surfaces that possess active sites having strong negative charge, thereby rendering the mineral surfaces less water loving (hydrophilic) and more water repelling (hydrophobic). A suitable hydrophobicity modifying agent is dodecylamine (DDA) having a molecular weight of about 185 Da and molecular formula of C₁₂H₂₇N. Other suitable hydrophobicity modifying agents include, but are not limited to, DDAHCI (dodecylamine hydrochloride, MW=221.81); DTAC (dodecyl-trimethylammonium chloride, MW=263.89); CTAB (cetyl-trimethylammonium bromide, MW=364.45). Other hydrophobicity modifying agents that may be useful in the present invention include other ammonium surfactants and phosphonium surfactants. Some hydrophobicity modifying agents act as collectors. Collectors are generally used in froth flotation and, as used herein, “collector” is a chemical that attaches to the mineral surface (in particular, clays) and produces a hydrophobic surface. The water-repellent surface facilitates the attachment of the mineral particle to an air bubble. Useful collectors may include oils, xanthates, dithiophosphates, petroleum sulfonates and fatty amines. Dodecylamine (DDA), dodecylamine hydrochloride (DDAHCI), dodecyl-trimethylammonium chloride (DTAC) and cetyl-trimethylammonium bromide (CTAB) can also be used as collectors.

As used herein, a “frothing agent” or “frother” refers to chemicals added to the process which have the ability to change the surface tension of a liquid such that the properties of the sparging bubbles are modified. Frothers may act to stabilize air bubbles so that they will remain well-dispersed in slurry, and will form a stable froth layer that can be removed before the bubbles burst. Ideally the frother should not enhance the flotation of unwanted material and the froth should have the tendency to break down when removed from the flotation apparatus. Frothers suitable for the present invention include alcohols (e.g., MIBC), polypropylene glycol ethers, glycol ethers, pine oil, cresol and paraffins.

As used herein, a “depressant” refers to a chemical that may depress quartz/feldspar and enhance the hydrophobicity difference between the clays and the quartz/feldspar, and hence increase the clay flotation selectivity. The typical silica depressant is sodium silicate (commonly referred to as “water glass”). A depressant may include pH modifying agents that have a strong impact on oxide mineral surface charges, and hence, on the adsorption of collectors and selectivity between silica and clays. For example, at pH 4 using a cationic collector such as DDA, clays have the maximum recovery while silica has the lowest recovery. Thus, pH modifiers also function as depressants to some extent.

In one embodiment of the present invention, flocculation/aggregation of tailings may be followed by treatment with a collector. Without being bound by any theory, treatment of the flocculated/aggregated tailings with a collector enhances the particle surface hydrophobicity, thereby reducing the affinity of the aggregates to retain water and increasing the hydraulic conductivity of the aggregates. This results in better solids liquid separation and a product which becomes more rapidly reclaimable.

Further, in the present invention, a hydrophobicity modifying agent, together with sufficient aeration, may be used to render the clays present in the tailings floatable in-situ so that the clays can be collected and removed from the tailings containment area for disposal.

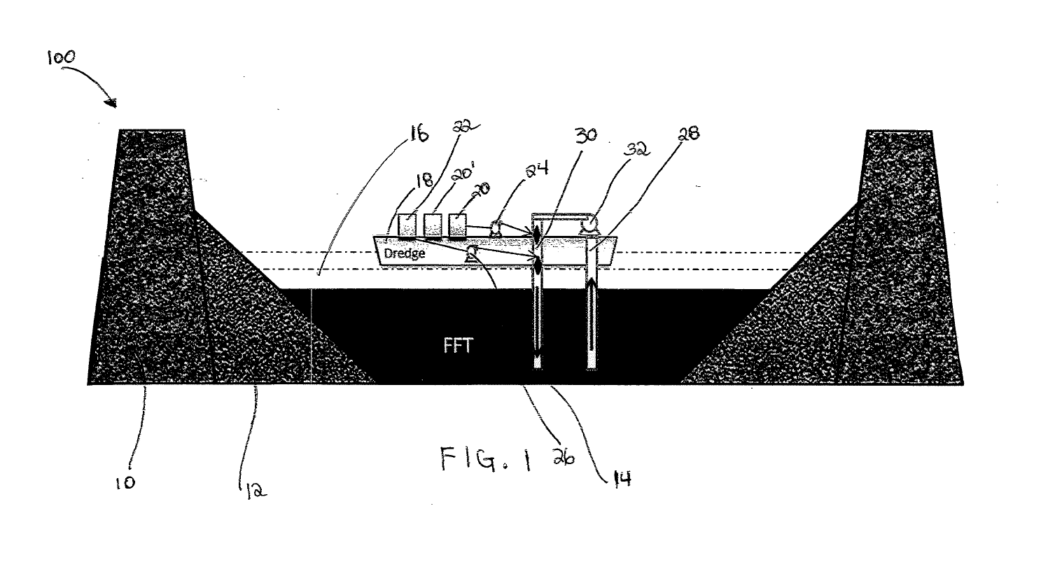

One embodiment of the present invention is shown in FIG. 1. Generally, a tailings pond 100 is a dam or an impoundment that is commonly made using “local materials”. For example, tailings pond 100 may comprise berms 10 made from, for example, packed tailings sand or overburden, and sand 12. It is understood, however, that a tailings pond could also an in-pit impoundment or a dug pit. When oil sand tailings are impounded in a tailings pond, the coarser and heavier sand settles out fairly quickly to form sand beaches 12; however, the fluid fine tailings 14 (FFT 14) will only consolidate to about 35 wt % solids. Forming on top of the tailings pond 100 is a substantial layer of water 16. Thus, a dredge or barge 18 can be used, which floats on the water 16, to treat the FFT 14 in-situ with various additives to enhance the dewatering/consolidation of FFT 14.

In the embodiment shown in FIG. 1, dredge 18 comprises a first pipe 28 (also referred to herein as FFT pipe 28), which is submerged into the FFT layer. Pump 32 (also referred to herein as re-circulation pump 32) will pump the FFT 14 from the tailings pond and recirculate the FFT 14 through a second pipe 30 (also referred to herein as the additive pipe 30). Tanks of additives are also present on the dredge 18. For example, dredge 18 may have two tanks which may contain a flocculant, a coagulant, or one of each (tanks 20 and 20′) and, optionally, a third tank which contains a hydrophobicity modifying agent (tank 22). A pump 24 is connected to tank 20 and/or 20′ and will inject flocculant, coagulant or both into the FFT 14 that is present in additive pipe 30. Similarly, a pump 26 is connected to tank 22 for pumping a hydrophobicity modifying agent from the tank and injecting the hydrophobicity modifying agent into the FFT 14 present in additive pipe 30. Generally, flocculant/coagulant is added first, followed by a hydrophobicity modifying agent. Flocculant/coagulant and hydrophobicity modifying agent can be prepared off-shore or can be prepared on dredge 18.

Thus, re-circulation pump 32 will mix the FFT 14 with the flocculant/coagulant and hydrophobicity modifying agent and deposit the treated FFT back to tailings pond 100. In one embodiment, an in-line static or dynamic mixer may be added to additive pipe 30 to aid in the mixing of the FFT and additives. Once the treated FFT is deposited back to the tailings pond, the flocs/aggregates will rapidly settle to the bottom of the tailings pond and release water to the surface of the tailings pond. The dredge 18 can then be slowly moved forward or backward from one place in the tailings pond to another.

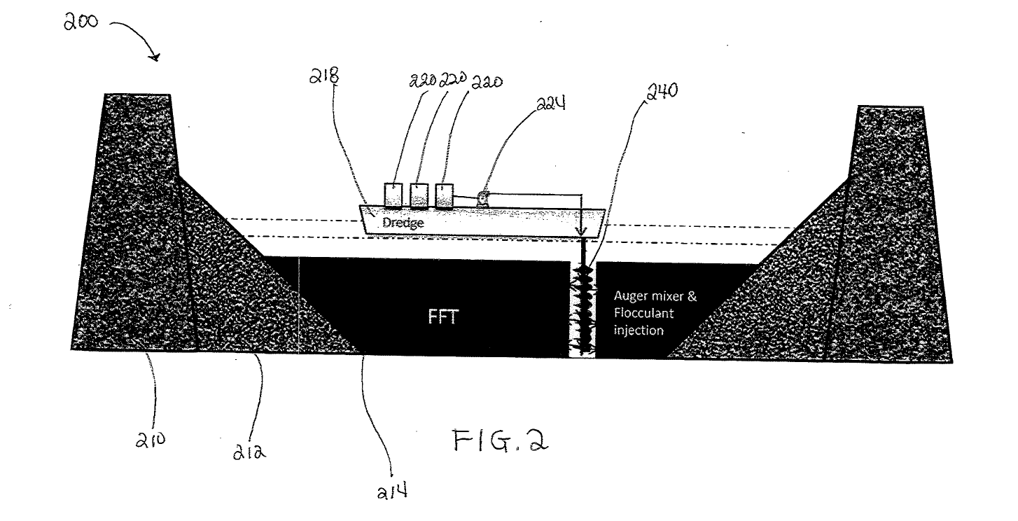

Another embodiment of the present invention is shown in FIG. 2. Once again, tailings pond 200 comprises berms 210 made from, for example, packed tailings sand or overburden, and sand 212. It is understood, however, that a tailings pond could also an in-pit impoundment or a dug pit. When oil sand tailings are impounded in a tailings pond, the heavier sand settles out fairly quickly to form sand beaches 212; however, the fluid fine tailings 214 (FFT 214) will only consolidate to about 35 wt % solids. Forming on top of the tailings pond 200 is a substantial layer of water 216. Thus, a dredge or barge 218 can be used, which floats on the water 216, to treat the FFT 214 in-situ with various additives to enhance the dewatering/consolidation of FFT 214.

In the embodiment shown in FIG. 2, dredge 218 comprises an auger 240, which is submerged into the FFT layer. Auger 240 is designed to inject an additive such as a flocculant into the FFT 2014 in-situ and mix FFT 214 and flocculant in-situ, as well. In one embodiment, auger 240 comprises a hollow shaft wherein flocculant is introduced. In another embodiment, auger 240 comprises multiple injection points for injecting the flocculant into the FFT. Dredge 218 further comprises tanks of additives, for example, flocculant tanks 220. It is understood, however, that other additives can be added to the FFT 214, such as coagulants and/or a hydrophobicity modifying agent. A pump 224 (flocculant pump 224) is connected to flocculant tanks 220 and will pump flocculant into the auger 240, which is designed to inject flocculant/other additives into the FFT 214. As previously mentioned, auger 240 is also a mixer, which will mix the flocculant with the FFT 214 in-situ.

The flocs/aggregates that are formed in-situ will rapidly settle to the bottom of the tailings pond and release water to the surface of the tailings pond. The dredge 218 can then be slowly moved forward or backward from one place in the tailings pond to another.

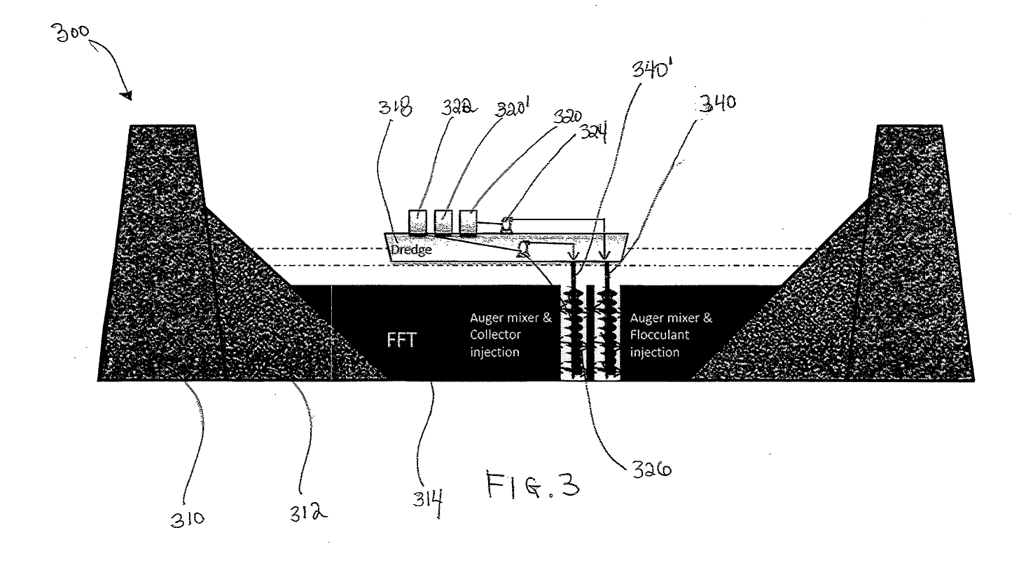

Another embodiment of the present invention is shown in FIG. 3. Tailings pond 300 comprises berms 310 and sand 312. As previously mentioned, when oil sand tailings are impounded in a tailings pond, the heavier sand settles out fairly quickly to form sand beaches 312; however, the fluid fine tailings 314 (FFT 314) will only consolidate to about 35 wt % solids. Forming on top of the tailings pond 300 is a substantial layer of water 316. Thus, a dredge or barge 318 can be used, which floats on the water 316, to treat the FFT 314 in-situ with various additives to enhance the dewatering/consolidation of FFT 314.

In the embodiment shown in FIG. 3, dredge 318 comprises a first auger 340 and a second auger 340′. First auger 340 is designed to inject flocculant into the FFT 314 and mix the FFT 314 and flocculant in-situ to form flocs or aggregates. Pump 324 pumps flocculant from flocculant tanks 320 and 320′ to first auger 340. Pump 326 is connected to tank 322 for pumping a hydrophobicity modifying agent from the tank and injecting the hydrophobicity modifying agent into the FFT 314 via second auger 340′. Generally, flocculant is added first, followed by a hydrophobicity modifying agent. Flocculant and hydrophobicity modifying agent can be prepared off-shore or can be prepared on dredge 318.

Thus, first and second augers 340, 340′ will mix the FFT 314 with the flocculant/hydrophobicity modifying agent in-situ in tailings pond 300. Thus, the flocs/aggregates are formed in-situ and will rapidly settle to the bottom of the tailings pond and release water to the surface of the tailings pond. The dredge 318 can then be slowly moved forward or backward from one place in the tailings pond to another.

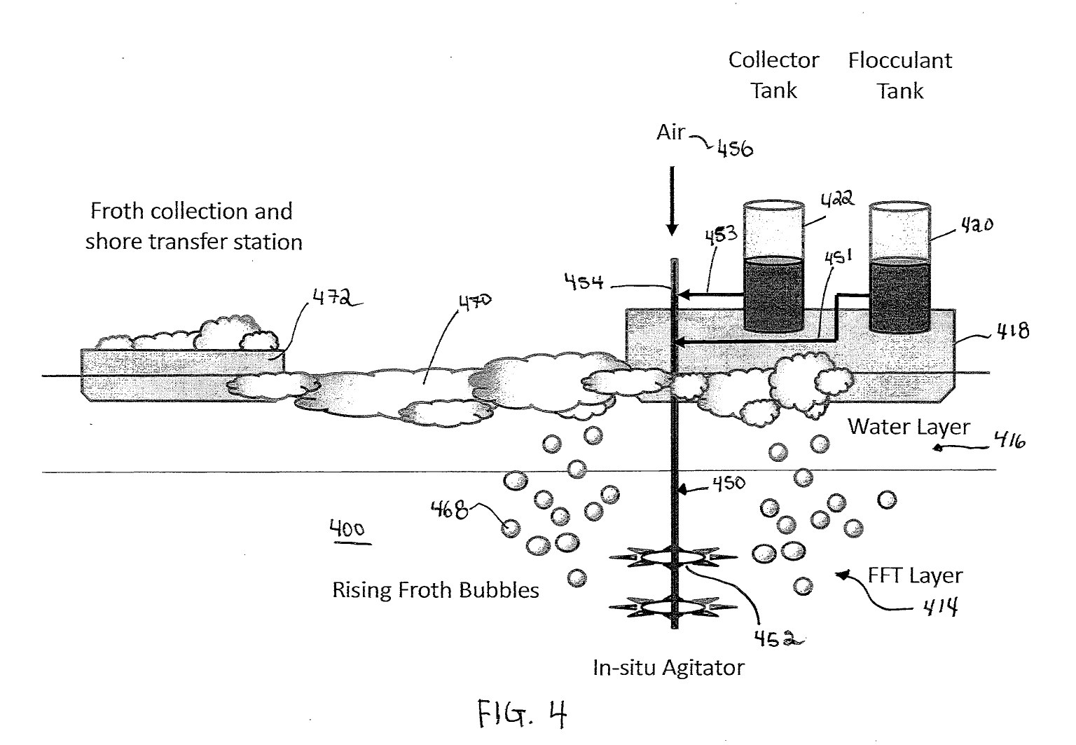

FIG. 4 is a schematic showing an embodiment of the present invention for in-situ treatment of fluid fine tailings (FFT) present in a tailings pond which is designed to float the clays present in the fluid fine tailings for removal. In particular, dredge 418 comprises at least one in-situ agitator 450 comprising a vertical pipe 454 having a number of agitating devices 452, for example, impellers. The barge 418 further comprises a flocculant tank 42 and a collector tank 422. The in-situ agitator 450 is designed to inject air 456, flocculant 451 and collector 453 into the FFT 514 and agitate the FFT 414, flocculant 451, clay surface agent (collector) 453 and air in-situ. The clays in the FFT will flocculate/aggregate and the clay surface agent (collector) will allow the flocculated/aggregated clays to attach to air bubbles to form froth bubbles 468, which will rise to the surface of the water layer 416 and form clay froth 470. The froth 470 can then be collected in a froth collection and shore transfer station 472 for removal. A froth collection and shore transfer station may comprise a mechanical or vacuum froth collection device and a pump to transfer the froth to a deposition site. In the alternative, and overflow weir system can be used. A surface water skimming device can be used to collect the froth and the froth can be transferred via a pump and pipeline to shore. The remaining non-clay solids will rapidly settle to the bottom of the tailings pond and release water to the surface of the tailings pond. The dredge 418 can then be slowly moved forward or backward from one place in the tailings pond to another.

In one embodiment, a frother can be added to stabilize air bubbles to form a stable froth layer. In another embodiment, a depressant can be added to depress non-clay solids such as quartz/feldspar.

### Example 1

In this example, fluid fine tailings (FFT) were treated with either flocculant alone or flocculant followed by a hydrophobicity modifying agent. The FFT used in this example ranged in solids concentrations from about 20-35 wt % solids and FFT comprising about 38.66 wt % solids. The flocculant used was an anionic, high molecular weight polyacrylamide, which is commercially available as SNF 3338. The hydrophobicity modifying agent used was dodecylamine (DDA).

A mixing tank was used to simulate in-situ mixing. The FFT was added to the mixing tank and the FFT was first treated with 800 g or 1000 g flocculant (SNF 3338) per tonne of tailings solids and mixed for 30 seconds to form large aggregates (i.e., flocs). The flocculated/aggregated FFT was then either treated with DDA at a dosage of 650 g/tonne of tailings solids or no further treatment was performed. When treated with DDA, the FFT flocculated/aggregated tailings were mixed for a further 30 seconds, to enhance the hydrophobicity of the flocs/aggregates. Several different mix conditions were tested, in particular, various H/T conditions were used, i.e., where H/T is the ratio of the slurry (tailings) height in the tank and the tank diameter. The mixing speed was also varied (250 rpm, 280 rpm or 300 rpm).

The dewatering capability of treated FFT was measured using a Triton Electronics Ltd. Capillary Suction Time tester to correlate dewatering efficiency with the chemical addition sequence. Dewaterability is measured as a function of how long it takes for water to travel radially between two ring electrodes through a filter and low values indicate rapid dewatering whereas high values indicate slow dewatering ability. Thus, a relatively low average capillary suction time (CST, seconds) indicates good dewatering. The results are shown in Table 1.

TABLE 1

| | Feed | | | | |
|---|---|---|---|---|---|
| Test # | Solids % | Mix Conditions | Flocculant | Collector | CST (sec) Ave |
| 1 | 20% | H/T = 0.65, 250 rpm | SNF 3338, 800 | None | 29 |
| | | | g/t | | |
| 2 | 25% | H/T = 0.65, 250 rpm | SNF 3338, 800 | None | 31 |
| | | | g/t | | |
| 3 | 30% | H/T = 0.65, 280 rpm | SNF 3338, 800 | None | 124 |
| | | | g/t | | |
| 4 | 35% | H/T = 0.65, 300 rpm | SNF 3338, 800 | None | 88 |
| | | | g/t | | |
| 5 | 38.66% | H/T = 0.4, 250 rpm | SNF 3338, | None | 920 |
| | | | 1000 g/t | | |
| 6 | 20% | H/T = 0.65, 250 rpm | SNF 3338, 800 | DDA, 650 g/t | 22 |
| | | | g/t | | |
| 7 | 25% | H/T = 0.65, 250 rpm | SNF 3338, 800 | DDA, 650 g/t | 20 |
| | | | g/t | | |
| 8 | 30% | H/T = 0.65, 280 rpm | SNF 3338, 800 | DDA, 650 g/t | 26 |
| | | | g/t | | |
| 9 | 35% | H/T = 0.65, 300 rpm | SNF 3338, 800 | DDA, 650 g/t | 50 |
| | | | g/t | | |
| 10 | 38.66% | H/T = 0.4, 250 rpm | SNF 3338, | DDA, 650 g/t | 21 |
| | | | 1000 g/t | | |

It can be seen from the results in Table 1 that, on average, treatment of FFT with a flocculant followed by treatment with a collector resulted in capillary suction times (CST, seconds) that were generally low, meaning that dewatering was occurring fairly rapidly. When FFT was treated with both flocculant and a collector, CST was even lower, indicating even better dewatering capability.

### Example 2

FFT samples having 12.5 wt. % solids were first treated/mixed with a high molecular weight, anionic polyacrylamide flocculant, which is commercially available under the name SNF 3338, at dosages of 0 g/tonne, 50 g/tonne, 100 g/tonne, 500 g/tonne and 800 g/tonne, and mixed for about 0.5 minutes. It is generally believed that anionic polyacrylamide polymers are selective for clays. A cationic collector DDA was then added at a dosage of 650 g/tonne and the tailings were further conditioned/mixed for 2 minutes. The thus-treated tailings were then subjected to 15 minutes flotation in a Denver flotation cell and the clay froth was retrieved. The total solids recoveries in the clay froths were then determined.

At the highest dosage of polymeric flocculant (800 g/t), the total solids recovered in the clay froth increased from about 47 wt. % (with no flocculant) to almost 80 wt %. Even when using very small amounts of polymeric flocculant (50-100 g/t), the clay/solids recovery increased by more than 10%. Without being bound by theory, it is believed that the addition of a clay-specific flocculant causes the clay particles to form larger flocs. These flocs can then be rendered hydrophobic by adding a collector such as a cationic clay collector, which then allows the clay flocs to separate from the silt/sand and float, while the silt/sand sinks to the bottom of the flotation cell as flotation tails.

From the foregoing description, one skilled in the art can easily ascertain the essential characteristics of this invention and adapt it to various usages and conditions. Reference to an element in the singular, such as by use of the article “a” or “an” is not intended to mean “one and only one” unless specifically so stated, but rather “one or more”. Nothing disclosed herein is intended to be dedicated to the public regardless of whether such disclosure is explicitly recited in the claims.

1. A process for the in-situ treatment of tailings in a containment area having a tailings layer comprising fine solids and water, comprising:
(a) adding a flocculant, a coagulant, a hydrophobicity modifying agent, or any combination thereof, into a portion of the tailings layer;
(b) mixing the portion of the tailings layer and flocculant, coagulant, hydrophobicity modifying agent, or combinations thereof, to form in-situ treated tailings; and
(c) allowing the in-situ treated tailings to dewater and/or consolidate in-situ in the tailings containment area.

2. The process of claim 1, the containment area further having a water layer on top of the tailings layer, whereby the treated tailings dewater and/or consolidate.

3. The process of claim 1, wherein steps (a) and (b) take place within a mixing vessel such as a pipe, an in-line static mixer, an in-line dynamic mixer or combinations thereof.

4. The process of claim 1, wherein a flocculant and a hydrophobicity modifying agent are used to treat the portion of the tailings.

5. The process of claim 4, wherein the hydrophobicity modifying agent is a collector comprising dodecylamine.

6. The process of claim 4, wherein the flocculant is mixed with the portion of the tailings prior to mixing the portion of the tailings with the hydrophobicity modifying agent.

7. The process as claimed in claims 4 to 6, wherein the flocculant comprises an anionic flocculant.

8. The process as claimed in claim 7, wherein the flocculant comprises an anionic polymeric flocculant.

9. The process of claim 7, wherein the dosage of the flocculant ranges from between about 0 to about 1500 grams per tonne of solids in the tailings.

10. The process of claim 7, wherein the flocculant comprises a polyacrylamide.

11. The process of claim 10, wherein the polyacrylamide has a molecular weight ranging between about 10 to about 24 million, and about 25-30% anionicity.

12. The process of claim 1, wherein the tailings are fluid fine tailings.

13. The process of claim 1, wherein the portion of tailings and flocculant, coagulant, hydrophobicity modifying agent, or combinations thereof, are mixed in-situ by means of at least one auger.

14. The process as claimed in claim 1, wherein a flocculant and a hydrophobicity modifying agent comprising a collector is added to the portion of the tailings in-situ, further comprising:
(d) adding air to the treated tailings in-situ to form a froth comprising clays that floats to the surface of the tailings containment area and the remaining solids consolidate.

15. The process as claimed in claim 14, wherein the froth is collected from the surface for disposal.
